(19) United States
(12) Patent Application Publication
(10) Pub. No.: US 2026/0206945 A1
(43) Pub. Date: Jul. 23, 2026

(54) Dispenser and operating method thereof

(71) Applicant: LG FAROUK CO., Seoul (KR)

(72) Inventor: Sung Taek OH, Seoul (KR)

(21) Appl. No.: 19/139,683

(22) PCT Filed: Dec. 12, 2023
(86) PCT No.: PCT/KR2023/020392

§ 371 Date: Jun. 16, 2025

(30) Foreign Application Priority Data
Dec. 16, 2022 (KR) 10- 2022-0177647

(51) Int. Cl. A45D 34/00; B67D 3/00

(52) U.S. Cl. CPC A45D 34/00; B67D 3/0019; B67D 3/0074; A45D 2034/005

(57) ABSTRACT

A dispenser, according to an embodiment of the present disclosure, may comprise: a housing; a main motor which is disposed inside the housing; a mounting body which rotates by means of the main motor, on which a plurality of cartridges are mounted, and includes a plurality of holders that secure each of the plurality of cartridges; and a holder bracket for properly fastening a holder that is not fastened to the cartridge from among the plurality of holders. The present disclosure intends to provide a dispenser that performs an automatic fastening operation to properly fasten an unfastened cartridge.

### TECHNICAL FIELD

The present disclosure relates to a dispenser for providing cosmetics such as foundation, hair dye, etc. and an operating method thereof.

### BACKGROUND ART

Recently, with the development of the beauty industry, the types of cosmetics have become very diverse. However, since each user has different skin and hair characteristics, there is a limit to supplying cosmetics that are suitable for each user. Accordingly, dispensers that provide cosmetics that are suitable for each user are being developed.

Cosmetics can include not only those used on the user's skin, such as foundation and sunscreen, but also those used on the user's hair, such as hair dye.

The dispenser can provide these cosmetics to the user by manufacturing them according to the preferences and tastes of each user. For example, the dispenser can dispense various compositions so that cosmetics that cover the skin or dye the hair in the color desired by the user are provided.

These dispensers are equipped with cartridges that contain various compositions, and these cartridges must be replaced by the user when the expiration date or the contents are exhausted.

In other words, the user installs or replaces the cartridges themselves, but when this happens, a problem may occur where the cartridges are not completely installed in the dispenser. If the cartridge is not properly installed in the designated location, a discharge error may occur.

Therefore, a method is required to check in advance whether the cartridge is properly installed when replacing the cartridge, etc.

### DISCLOSURE

### Technical Problem

The present disclosure seeks to provide a dispenser that verifies whether a cartridge is normally mounted.

The present disclosure seeks to provide a dispenser that performs an automatic mounting operation to normally mount an unmounted cartridge.

### Technical Solution

A dispenser according to an embodiment of present disclosure may comprise a housing, a main motor arranged inside the housing, a mounting body that rotates by the main motor, equipped with a plurality of cartridges, and includes a plurality of holders that fix each of the plurality of cartridges, and a holder bracket for normally mounting unmounted holder among the plurality of holders.

A protrusion that applies pressure to the unmounted holder can be formed in the holder bracket.

At least one inclined surface can be formed on a lower part of the holder bracket.

A height of the inclined surface can be decreased along a rotational direction of the mounting body.

The holder bracket can be installed so that the inclined surface forms an angle of 5 to 85 degrees with a rotational plane of the mounting body.

The holder bracket can be installed so as to be spaced apart from a holder that is normally connected by a predetermined distance.

The mounting body may rotate at least once when performing an automatic mounting operation to normally mount the unmounted holder.

The dispenser can comprise a rotation detection sensor configured to detect whether the mounting body is rotated, and the mounting body can stop the automatic mounting operation if the mounting body does not rotate.

The dispenser can comprise a rotation detection sensor configured to detect whether the mounting body is rotated, and output an alarm to indicate a poor holder mounting if the mounting body does not rotate.

A door is formed on one side of the housing, and an automatic mounting operation is performed to normally mount the unmounted holder when the door is opened and then closed.

The dispenser can comprise a door sensor for detecting whether the door is opened or closed.

### Advantageous Effects

According to an embodiment of the present disclosure, if it is estimated that a cartridge replacement operation has been performed, an operation for automatically checking whether the cartridge is mounted is performed, so that there is an advantage in minimizing problems such as ejection errors due to abnormal mounting of the cartridge.

According to an embodiment of the present disclosure, if a holder that fixes a cartridge is not mounted to the cartridge, it is automatically mounted by the holder bracket, so that there is an advantage in minimizing inconvenience of the user having to mount the holder to the cartridge one by one.

According to an embodiment of the present disclosure, if automatic mounting is difficult, there is an advantage in that the occurrence of a problem can be prevented in advance by generating an alarm and stopping the automatic mounting operation.

### DESCRIPTION OF DRAWINGS

FIG. 1 is a block diagram of a cosmetics providing system according to an embodiment of the present disclosure.

FIG. 2 is a perspective view of a dispenser according to an embodiment of the present disclosure.

FIG. 3 is a perspective view showing a state in which a receiving body is separated from the dispenser shown in FIG. 2.

FIG. 4 is a drawing showing an interior of a dispenser according to an embodiment of the present disclosure.

FIG. 5 is a drawing showing a portion of a cartridge and an elevating body according to an embodiment of the present disclosure from a side view.

FIG. 6 is a drawing showing a portion of a cartridge, an elevating body and an elevating motor according to an embodiment of the present disclosure from a front view.

FIG. 7 is a plan view showing a rotation path of a cartridge and an elevating motor according to an embodiment of the present disclosure.

FIG. 8 is a drawing showing a plurality of cartridges and a mounting body according to an embodiment of the present disclosure.

FIG. 9 is an exemplary drawing showing a dispenser according to an embodiment of the present disclosure in which a holder is not properly mounted on a cartridge.

FIG. 10 is a front view showing the interior of a dispenser including a holder bracket according to an embodiment of the present disclosure.

FIG. 11 is a perspective view showing the interior of a dispenser including a holder bracket according to an embodiment of the present disclosure.

FIG. 12 is a control block diagram for explaining an operating method of a dispenser according to an embodiment of the present disclosure.

FIG. 13 is a flowchart for explaining an operating method of a dispenser according to an embodiment of the present disclosure.

### BEST MODE

Hereinafter, the embodiments disclosed in this specification will be described in detail with reference to the attached drawings. Regardless of the drawing symbols, identical or similar components will be given the same reference numbers and redundant descriptions thereof will be omitted.

The suffixes “module” and “part” used for components in the following description are given or used interchangeably only for the convenience of writing the specification, and do not have distinct meanings or roles in themselves.

In addition, when describing the embodiments disclosed in this specification, if it is determined that a specific description of a related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the spirit and technical scope of the present disclosure.

Terms including ordinal numbers such as first, second, etc. may be used to describe various components, but the components are not limited by the terms. The terms are used only for the purpose of distinguishing one component from another.

Singular expressions include plural expressions unless the context clearly indicates otherwise.

In this application, the terms “comprise” or “have” should be understood to indicate the presence of a feature, number, step, operation, component, part, or combination thereof described in the specification, but not to preclude the possibility of the presence or addition of one or more other features, numbers, steps, operations, components, parts, or combinations thereof.

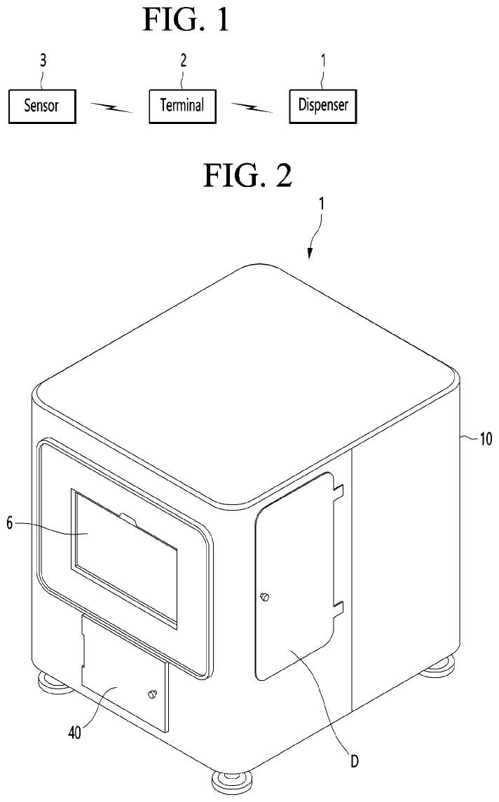

FIG. 1 is a block diagram of a cosmetics providing system according to an embodiment of the present disclosure.

The cosmetics providing system according to an embodiment of the present disclosure may include at least some or all of a dispenser 1, a terminal 2, and a sensor 3. Each of the dispenser 1, the terminal 2, and the sensor 3 may communicate with each other to transmit and receive signals.

The dispenser 1 includes a plurality of compositions, and may discharge at least one composition upon receiving a manufacturing command to provide cosmetics.

Here, the composition may refer to an ingredient used in manufacturing cosmetics, such as foundation, dye, etc. The composition may include raw materials, compounds, etc. used in manufacturing cosmetics.

The cosmetics may refer to a manufactured product provided by discharging at least one composition.

For example, if the dispenser 1 is a device that provides dye, the composition may refer to a dyeing material. The dyeing material may include both chemical components and natural components, and may include oxidation dyes expressing colors, natural dyes, oxidizing agents, alkaline agents, and auxiliary components for protecting hair. For example, the oxidation dyes may include paraphenylene diamine expressing black, paratrilene diamine expressing black-brown, and mononitrol phenylene diamine expressing red, and the oxidizing agents may include hydrogen peroxide, urea peroxide, sodium perborate, and the alkaline agents may include ammonia, surfactants, monoethanolamine, and the like.

In addition, the dyeing material may include acid dyes, basic dyes, HC dyes, direct dyes, and bleaching agents, and the like.

The composition may be a compound in which two or more chemical components are mixed, a compound in which two or more natural components are mixed, or a compound in which one or more chemical components and one or more natural components are mixed.

The cosmetic is provided by discharging at least one of the above-described compositions suitable for use on the user's skin or hair, and may be manufactured by discharging any one of the plurality of compositions, or may be manufactured by discharging at least two of the plurality of compositions.

The terminal 2 may receive a command to select a target color from the user. The terminal 2 may display at least one sample color, and may receive a command to select the target color through a command to select any one of the displayed sample colors. The selected color among the sample colors may be the target color.

Here, the sample color may indicate in advance the color of the skin or hair expected to be colored by the use of the cosmetic, and may mean an example color. The target color may be a color selected by the user to be colored by the cosmetic to be manufactured.

The terminal 2 is a device that is capable of wired/wireless communication and has a display and input unit, and may include a mobile terminal such as a smart phone, a smart watch, a tablet, a personal computer (PC), etc., but this is only an example and is not limited thereto.

Meanwhile, although the dispenser 1 and the terminal 2 are illustrated as being separate in FIG. 1, the dispenser 1 and the terminal 2 may be formed as one unit.

The sensor 3 can measure a color of skin or hair that is the target of cosmetic use. The sensor 3 may be a separate device distinct from the dispenser 1 or the terminal 2, or may be a component of the dispenser 1 or the terminal 2.

The sensor 3 can measure a current color of skin or hair before the cosmetic is used, or a result color, which is the color of skin or hair after the cosmetic is used. In addition, the sensor 3 can measure a color of skin or hair while the cosmetic is being used.

The sensor 3 may be a spectrophotometer. That is, the sensor 3 can measure the color of skin or hair by obtaining the values of three properties of skin or hair at a location in contact with skin or hair, or adjacent to skin or hair.

According to an embodiment of the present disclosure, the cosmetics providing system may have the sensor 3 measure the current color of hair and transmit the current color information to the dispenser 1, and the terminal 2 may transmit the target color information to the dispenser 1 after receiving a command to select a target color. When the dispenser 1 receives the current color information from the sensor 3 and the target color information from the terminal 2, the dispenser 1 may calculate a manufacturing method of a cosmetic that causes skin or hair to develop from the current color to the target color, and may discharge a composition according to the calculated manufacturing method of the cosmetic to provide the cosmetic.

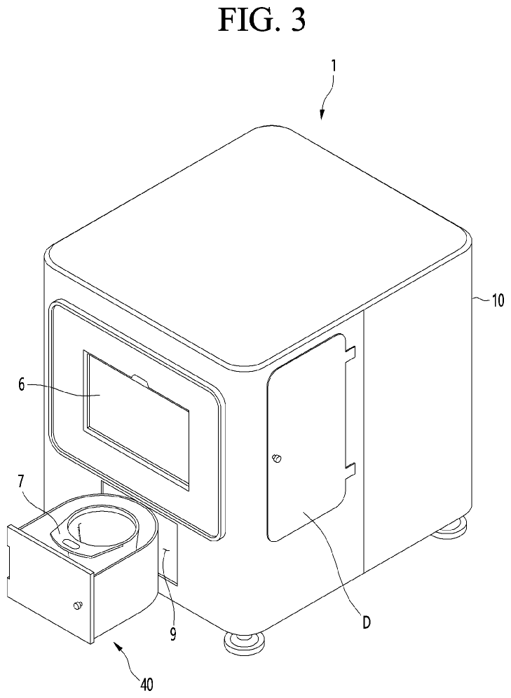

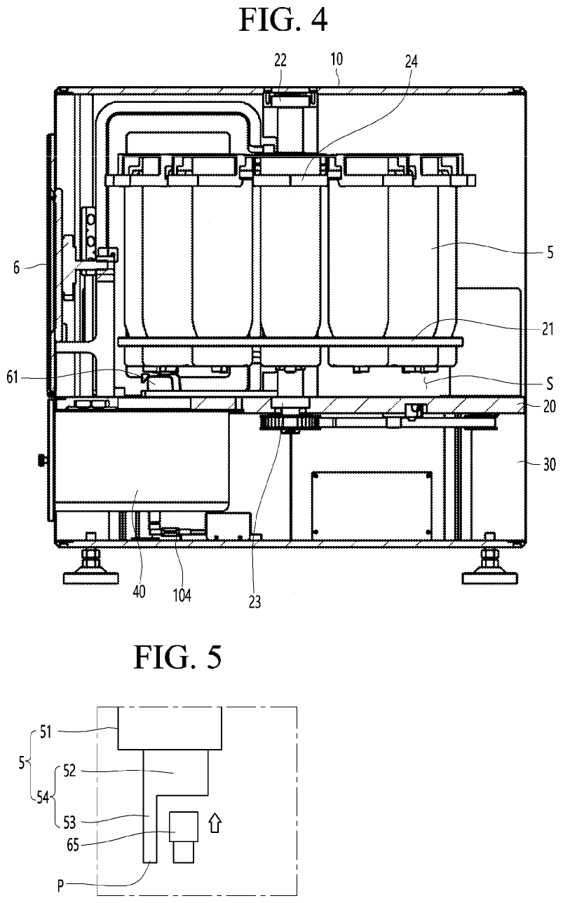

FIG. 2 is a perspective view of a dispenser according to an embodiment of the present disclosure, FIG. 3 is a perspective view illustrating a receiving body separated from the dispenser illustrated in FIG. 2, and FIG. 4 is a drawing illustrating the inside of a dispenser according to an embodiment of the present disclosure.

The dispenser 1 may include at least a part or all of a housing 10, a plurality of cartridges 5 arranged inside the housing 10 and containing a composition, a main body 20 in which the plurality of cartridges 5 are rotatably arranged, a main motor 30 that rotates the plurality of cartridges 5, an elevator motor 61 that is driven when the composition contained in the plurality of cartridges 5 is discharged, and a receiving body 40 in which a cosmetic manufactured with the composition discharged from at least one of the plurality of cartridges 5 is provided.

The housing 10 may protect components contained inside the dispenser 1. A plurality of cartridges 5, a main body 20, a main motor 30, an elevator motor 61, and a receiving body 40 may be arranged inside the dispenser 1.

The housing 10 may have a hexahedral shape having a space formed inside. Preferably, the housing 10 may be a rectangular or hexahedral shape with each face being a square, but this is only an example and is not limited thereto.

The display 6 may be formed on the front surface of the housing 10. The display 6 may display various information related to the provision of cosmetics.

In addition, a receiving body 40 may be mounted or detached from the housing 10 through the front surface of the housing 10. The receiving body 40 may be detached from the housing 10.

A door D may be formed in the housing 10. The door D may be formed on one of the rear (opposite side of the front), side, or top surface of the housing 10.

The door D may be opened and closed when at least one cartridge 5 accommodated inside the housing 10 is replaced.

The cross-sectional area of the door D may be larger than the cross-sectional area of one cartridge 5. Accordingly, each of the plurality of cartridges 5 may pass through the door D, and the user may easily replace the cartridge 5 through the door D.

The shape of the housing 10 illustrated in the drawing is only exemplary and is not limited thereto.

A receiving body space 9 in which a receiving body 40 is placed may be formed in the housing 10. The receiving body 40 may be mounted to the housing 10 by being placed in the receiving body space 9, or may be detached from the housing 10 by being separated from the receiving body space 9. The receiving body space 9 may be a passage through which cosmetics made of compositions discharged from the plurality of cartridges 5 are provided to the outside.

A user may place the receiving body 40 inside the housing 10 or remove it to the outside through the receiving body space 9.

A basket 7 that receives the composition discharged from a plurality of cartridges 5 may be arranged in the receiving body 40.

The basket 7 may be placed inside the receiving body 40 or may be separated from the receiving body 40.

In this case, the user may easily receive cosmetics through the basket 7 and may easily wash the receiving body 40 separated from the housing 10.

Meanwhile, in FIGS. 2 and 3, the receiving body space 9 and the display 6 are illustrated as being formed on the same surface of the housing 10, but depending on the embodiment, the receiving body space 9 and the display 6 may each be formed on different surfaces of the housing 10.

As illustrated in FIG. 4, inside the housing 10, a plurality of cartridges 5, a mounting body 21 on which each of the plurality of cartridges 5 is mounted, a support body 22 supporting the mounting body 21, a main body 20 supporting at least one of the mounting body 21 and the support body 22, a main motor 30 rotating the mounting body 21, a lifting body 65 (see FIG. 5) that elevates so that a composition is discharged from one of the plurality of cartridges 5, an elevator motor 61 that drives the lifting body 65, etc. may be arranged.

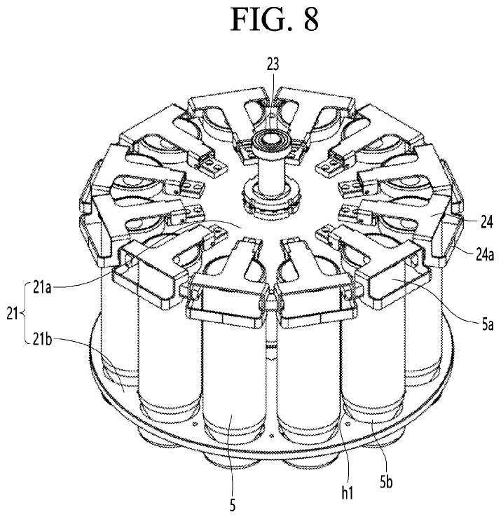

The mounting body 21 has a circular outer circumference, and a plurality of cartridges 5 may be mounted. A plurality of cartridges 5 can be interchangeably mounted on the mounting body 21. A plurality of mounting holes h1 (see FIG. 8) in which a plurality of cartridges 5 are respectively mounted, can be formed spaced apart along a circular shape on the mounting body 21. A plurality of cartridges 5 can be positioned by penetrating through each of the plurality of mounting holes h1. In particular, each of the plurality of cartridges 5 may have an actuator 54 (see FIG. 5) positioned facing downwards through each of a plurality of mounting holes h1.

The support body 22 can support the mounting body 21. The support body 22 can support a power transmission shaft 23 formed at the center of the mounting body 21.

The power transmission shaft 23 is connected at one end to the main motor 30 and can be arranged at the center of the mounting body 21.

A part of the power transmission shaft 23 can be arranged to penetrate the center hole (not shown) formed at the center of the mounting body 21. The power transmission shaft 23 can transmit the power of the main motor 30 to the mounting body 21. Therefore, the mounting body 21 rotates by the driving of the main motor 30, and accordingly, the plurality of cartridges 5 can rotate.

The main body 20 can support at least one of the mounting body 21 and the support body 22. In addition, the main body 20 can support the elevator body 65 (see FIG. 5) and the elevator motor 61.

In addition, a plurality of holders 24 can be formed in the mounting body 21. Each of the plurality of holders 24 can fix a plurality of cartridges 5, respectively.

In addition, a receiving body 40 may be arranged inside the housing 10, and a weight sensor 104 may be installed under the arrangement space of the receiving body 40. When the receiving body 40 is mounted on the housing 10, the weight sensor 104 may detect the weight of the basket 7 arranged inside the receiving body 40.

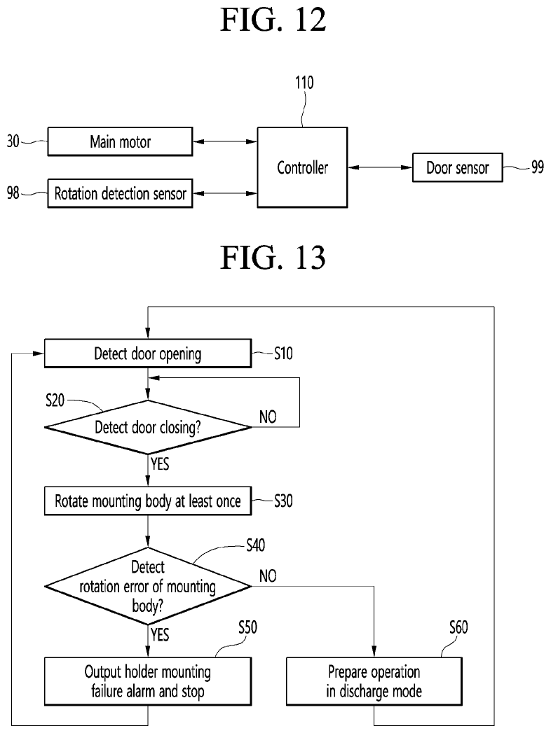

The dispenser 1 may further include a controller 110 (see FIG. 12) configured to control the main motor 30 and the elevator motor 61 so that a composition is discharged from at least one of the plurality of cartridges 5 according to a cosmetic manufacturing method.

The controller 110 may be arranged inside the housing 10 adjacent to the display 6, but this is merely exemplary, and the controller 110 may be arranged at any location within the housing 10.

The controller 110 can receive cosmetic-related information from the terminal 2 through a communication unit (not shown) or input cosmetic-related information from the display 6 configured as a touch panel to calculate a cosmetic manufacturing method.

The cosmetic manufacturing method can include information on the type of composition to be discharged and information on the amount of the composition to be discharged.

The controller 110 can control the main motor 30 and the elevator motor 61 so that the composition is discharged in a determined amount from at least one cartridge 5 according to the cosmetic manufacturing method.

The main motor 30 generates driving force, and the driving force generated from the main motor 30 is transmitted to the mounting body 21 through the power transmission shaft 23 so that the mounting body 21 can rotate. The controller 110 can control the main motor 30 to position the cartridge 5 containing the composition to be discharged in the discharging area.

Here, the discharging area may mean a position where the cartridge 5 containing the composition to be discharged is arranged vertically parallel to the basket 7.

When the composition to be discharged is located in the discharging area, the controller 110 can control the discharging amount of the composition by controlling the elevator motor 61.

The controller 110 can control at least one of the lifting height and the lifting speed of the lifting body 65 (see FIG. 5) through the elevator motor 61 to adjust the discharging amount of the composition.

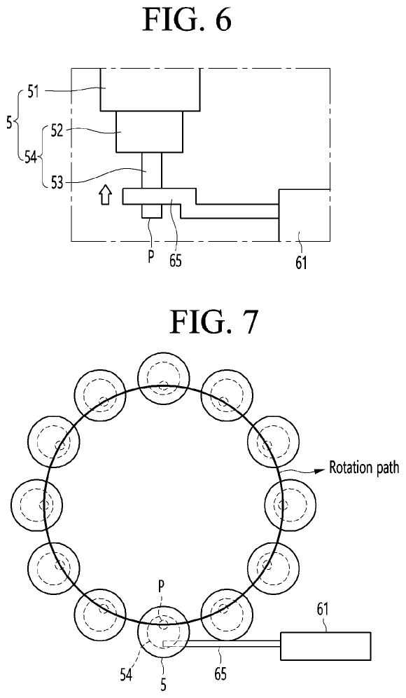

FIG. 5 is a drawing showing a part of a cartridge and a lifting body according to an embodiment of the present disclosure from a side view, FIG. 6 is a drawing showing a part of a cartridge, a lifting body and a lifting motor according to an embodiment of the present disclosure from a front view, and FIG. 7 is a plan view showing a rotation path of a cartridge and a lifting motor according to an embodiment of the present disclosure.

The elevator motor 61 can raise or lower the lifting body 65.

The lifting body 65 can pressurize one cartridge 5 when rising and can be separated from the pressurized cartridge 5 when lowered. The lifting body 65 can discharge the composition contained in the cartridge 5 by pressurizing the cartridge 5, particularly the actuator 54.

The lifting body 65 can move up and down so that the composition is discharged from one of the plurality of cartridges 5. The lifting body 65 can move up or down to selectively drive the actuator 54.

The elevator motor 61 can be mounted on the main body 20. The lifting body 65 can be arranged in a space S between the plurality of cartridges 5 and the main body 20.

The lifting body 65 may have a straight shape. That is, the lifting body 65 may not be bent. Accordingly, the production process of the lifting body 65 may be facilitated.

The lifting body 65 may be arranged to be separated from the rotation path in which the plurality of cartridges 5 rotate. According to one embodiment, the elevator motor 61 may be installed closer to the front side of the housing 10 than the mounting body 21, and the lifting body 65 may be connected to the side of the elevator motor 61.

In this case, when the plurality of cartridges 5 rotates, the problem that at least some of the plurality of cartridges 5 are caught by the lifting body 65 may be minimized. For example, if at least part of the lifting path of the lifting body 65 interfere with the rotation path in which the plurality of cartridges 5 rotates, a malfunction may occur, causing the cartridge 5 and the lifting body 65 to collide and be damaged. However, as in the present disclosure, if the lifting body 65 is arranged so that the lifting path of the lifting body 65 does not overlap with the rotation path along which the plurality of cartridges 5 rotate, the interference problem between the lifting body 65 and the cartridges 5 can be minimized. At this time, the lifting path is a path along which the lifting body 65 moves up and down, and the rotation path is a path along which the exits P of each of the plurality of cartridges 5 move when the plurality of cartridges 5 rotates, and may be a virtual circular shape.

In addition, since the lifting body 65 is arranged to be separated from the rotation path in which the plurality of cartridges 5 rotates, the problem of the composition hanging on the exit P of the cartridge 5 being stained to the lifting body 65 while rotating can be minimized. In other words, there is an advantage in that the contamination problem of the lifting body 65 is minimized.

Each of the plurality of cartridges 5 is formed with a container 51 containing the composition and an actuator 54 that discharges the composition contained in the container 51, and the actuator 54 may be formed with a discharge body 53 having an exit P through which the composition contained in the container 51 moves to the outside, and an activating body 52 that opens the exit P according to pressure. The exit P may be a passage through which the composition stored in the container 51 moves to the outside.

As shown in FIGS. 5 to 7, when the lifting body 65 is spaced apart from the activating body 52, the exit P may be closed, and in this case, the composition may not be discharged from the container 51.

Meanwhile, when the lifting body 65 rises and comes into contact with the activating body 52 and pressure is applied to the activating body 52, the exit P may be opened. In particular, the area of the exit P that is opened may become wider as the pressure applied to the activating body 52 increases. That is, the greater the pressure that the lifting body 65 applies to the activating body 52, the greater the amount of the composition discharged from the exit P, and the smaller the pressure that the lifting body 65 applies to the activating body 52, the less the amount of the composition discharged from the exit P.

In this way, the dispenser 1 according to an embodiment of the present invention can discharge a composition by having a lifting body 65 pressurize an activating body 52. At this time, the composition can include all of a liquid type, a cream type, or an oil type. That is, the dispenser 1 can discharge a liquid type composition, a cream type composition, or an oil type composition contained in cartridge 5. In this way, the dispenser 1 according to an embodiment of the present invention has an advantage of being able to discharge a composition regardless of the component state of the composition.

Meanwhile, the cartridge 5 can be fixed by a holder 24.

FIG. 8 is a drawing illustrating a plurality of cartridges and a mounting body according to an embodiment of the present disclosure.

The mounting body 21 is a member on which a plurality of cartridges 5 are mounted, and can rotate clockwise or counterclockwise. The mounting body 21 may be a turn table.

The mounting body 21 may include an upper mounting body 21a to which a plurality of holders 24 are connected, and a lower mounting body 21b in which a plurality of mounting holes h1 are formed.

A plurality of holders 24 may be installed on the upper mounting body 21a to fix each of the plurality of cartridges 5.

The upper part 5a of each of the plurality of cartridges 5 may be fixed by a plurality of holders 24, and the lower part 5b of each of the plurality of cartridges 5 may be fixed by a plurality of mounting holes h1.

The holder 24 can secure the plurality of cartridges 5 by wrapping the upper part 5a of each of the plurality of cartridges 5. Specifically, each of the plurality of holders 24 is connected to the upper mounting body 21a by a spring, and when the lever 24a of the holder 24 is pulled outward, the elasticity of the spring is weakened so that the holder 24 can be raised, thereby securing a space for replacing the cartridge 5. That is, when the lever 24a is pulled outward and raised, the holder 24 can be separated from the cartridge 5.

Then, when the external force that was pulling the lever 24a outward is removed, the elasticity of the spring is strengthened and it is pulled inward. Therefore, when the external force that was pulling the lever 24a outward is removed while it is lowered, the holder 24 is connected to the cartridge 5, so that the cartridge 5 can be fixed.

In summary, the holder 24 can be mounted to or separated from cartridge 5 by the elastic force of the spring connected to holder 24. In this case, since there is no need for a structure to apply pressure to each cartridge 5 so that cartridge 5 is mounted, the increase in volume due to the fixing structure of cartridge 5 can be minimized. In other words, there is an advantage in that the dispenser 1 can be miniaturized through this fixing structure of cartridge 5, and thus the manufacturing cost can be reduced.

The user can separate the holder 24 from the cartridge 5 by pulling up the lever 24a, and replace the cartridge 5 in this state. When the replacement of the cartridge 5 is completed, the user can mount the holder 24 to the cartridge 5 by pulling down the lever 24a and then releasing it.

However, during the process of replacing the cartridge 5, a problem may occur in which the holder 24 is not completely mounted to the cartridge 5.

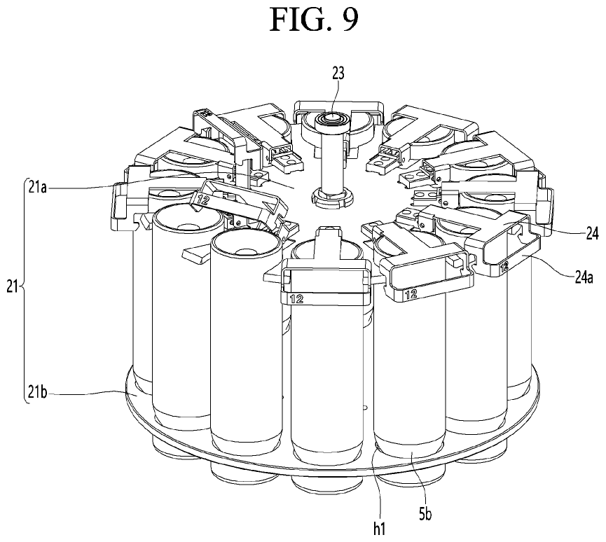

FIG. 9 is an exemplary drawing showing a dispenser according to an embodiment of the present disclosure in which the holder is not properly mounted on the cartridge.

As illustrated in FIG. 9, the holder 24 may not be properly mounted to the cartridge 5 due to reasons such as at least one of a plurality of holders 24 not being completely lowered. Referring to FIG. 9, it can be confirmed that one of the holders 24 is completely raised, and another of the holders 24 is raised to about half the maximum height.

If the holder 24 is not normally mounted to the cartridge 5, it is difficult for the user to recognize this problem until the dispensing operation is performed, and the dispensing operation may not be performed normally in this state. Therefore, the dispensing accuracy is reduced, and side effects such as having to discard the already dispensed composition may occur.

Therefore, the present disclosure can propose a structure for mounting a holder 24 that is not normally mounted to the cartridge 5 to the cartridge 5. The dispenser 10 according to an embodiment of the present disclosure can include a holder bracket 100 for normally mounting a holder 24 that is not mounted to a cartridge 5 among the plurality of holders 24.

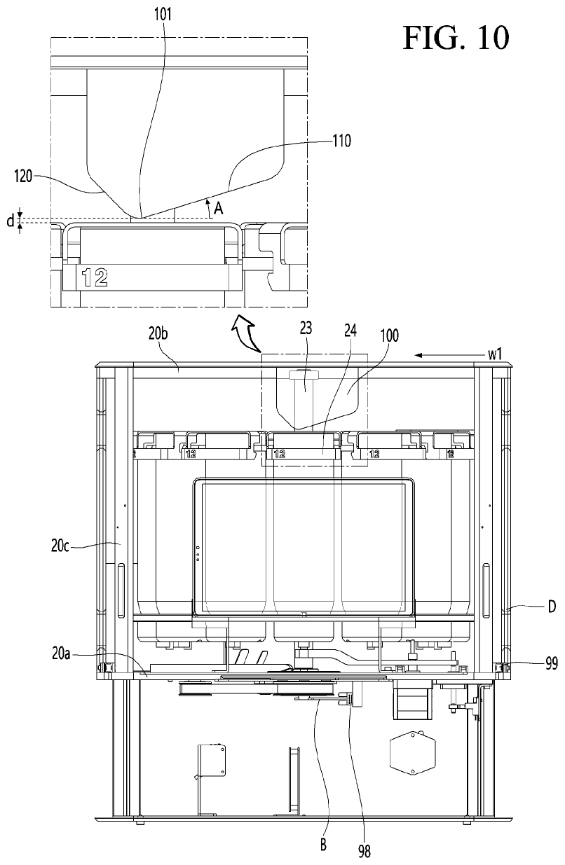

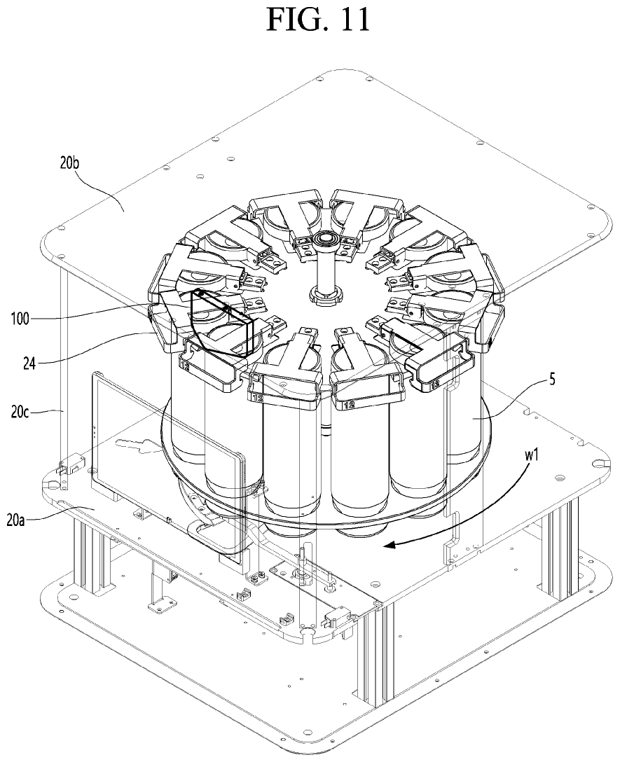

FIG. 10 is a front view illustrating the interior of a dispenser including a holder bracket according to an embodiment of the present disclosure, and FIG. 11 is a perspective view illustrating the interior of a dispenser including a holder bracket according to an embodiment of the present disclosure.

According to one embodiment, the holder bracket 100 may be installed in a form that is mounted to the upper surface of the housing 10.

According to another embodiment, as illustrated in FIG. 10, the holder bracket 100 may be mounted to the main body 20. Specifically, the main body 20 includes a lower plate 20a and an upper plate 20b that support a power transmission shaft 23 and a plurality of pillars 20c that support the upper plate 20b, and the holder bracket 100 may be installed in a form that is mounted to the upper plate 20b.

The holder bracket 100 may be formed with a protrusion 101 that applies pressure to the holder 24 that is not mounted to the cartridge 5. The protrusion 101 may be formed in a form that protrudes in the direction of the holder 24. The holder bracket 100 can be installed at a position where the protrusion 101 is spaced apart from the holder 24 that is normally mounted to the cartridge 5 by a set distance d. That is, the holder bracket 100 can be installed so as to be spaced apart from the holder that is normally mounted by a set distance d. At this time, the set distance d can be about 1 mm to 5 mm, but this is only an example, and it is reasonable that it is not limited thereto. Accordingly, when the holder 24 is normally mounted to the cartridge 5, the holder 24 may not come into contact with the holder bracket 100 while the mounting body 21 rotates.

Meanwhile, when the holder 24 is normally mounted to the cartridge 5, the holder 24 is lifted upward, and thus the holder 24 may come into contact with the holder bracket 100 while the mounting body 21 rotates. That is, when the mounting body 21 rotates, the holder bracket 100 can apply downward pressure to the unmounted holder 24. In particular, the protrusion 101 can press the holder 24, which is not mounted with the cartridge 5, toward the cartridge 5 to mount it with the cartridge 5.

And, at least one inclined surface 110 120 may be formed on the lower part of the holder bracket 100.

First, a first inclined surface 110 may be formed on the lower part of the holder bracket 100. The first inclined surface 110 may be a surface that comes into contact with an unmounted holder among the plurality of holders 24 that rotate along the rotation direction w1 of the mounting body 21. The rotation direction w1 of the mounting body 21 may mean a direction in which the dispenser 10 rotates when it operates in the discharge mode. The first inclined surface 110 may be a surface for pressing an unmounted holder downward to mount it to the cartridge 5. A holder 24 that is normally mounted to the cartridge 5 may not come into contact with the first inclined surface 110.

The first inclined surface 110 may be formed to have a lower height along the rotation direction w1 of the mounting body 21. The first inclined surface 110 may be formed to narrow the distance from the holder 24 that rotates along the rotation direction w1 of the mounting body 21.

The first inclined surface 110 may be formed to form a predetermined angle A with a rotational plane of the mounting body 21, and the angle A may be 5 to 85 degrees, but this is only an example and is not limited thereto.

A second inclined surface 120 may be further formed on the lower portion of the holder bracket 100. The second inclined surface 120 may be a surface for mounting an unmounted holder to the cartridge 5 when the mounting body 21 rotates in a direction opposite to the rotation direction w1. Alternatively, the second inclined surface 120 may be a surface for alleviating a collision that occurs when an unmounted holder collides with the holder bracket 100 when the mounting body 21 rotates in a direction opposite to the rotation direction w1.

The second inclined surface 120 may be formed to have a higher height along the rotation direction w1 of the mounting body 21. The second inclined surface 120 may be formed to have a lower height along the opposite direction of the rotation direction w1 of the mounting body 21. The second inclined surface 112 may be formed to have a greater distance from the holder 24 that rotates along the rotation direction w1 of the mounting body 21. The second inclined surface 112 may be formed to have a smaller distance from the holder 24 that rotates along the opposite direction of the rotation direction w1 of the mounting body 21.

The second inclined surface 120 may be formed to have a predetermined angle with the rotation plane of the mounting body 21. The angle between the second inclined surface 120 and the rotation plane of the mounting body 21 may be the same as or different from the angle between the first inclined surface 110 and the rotation plane of the mounting body 21.

The second inclined surface 120 may be formed on the opposite side of the first inclined surface 110 with the protrusion 101 in between. That is, the protrusion 101 may be formed between the first inclined surface 110 and the second inclined surface 120.

Meanwhile, depending on the embodiment, the second inclined surface 120 may be omitted.

At least one holder bracket 100 may be provided in the dispenser 10. The dispenser 10 may include one or more holder brackets 100.

In addition, the dispenser 1 according to the embodiment of the present disclosure may provide a function for automatically checking whether the cartridge 5 is properly mounted. That is, the dispenser 1 may provide a function for checking whether the holder 24 is normally mounted to the cartridge 5 and whether the cartridge 5 is properly mounted.

According to one embodiment, the dispenser 1 can automatically perform an operation to check whether the holder 24 is mounted to the cartridge 5 when the cartridge 5 is replaced.

According to another embodiment, the dispenser 1 can perform an operation to check whether the holder 24 is mounted to the cartridge 5 when receiving an inspection command through user input.

Next, with reference to FIGS. 12 and 13, an operation method for the dispenser 10 according to an embodiment of the present disclosure to check whether the holder 24 is normally mounted to the cartridge 5 will be described.

FIG. 12 is a control block diagram for explaining the operation method of the dispenser according to the embodiment of the present disclosure.

The dispenser 10 may include a main motor 30, a rotation detection sensor 98, a door sensor 99, and a controller 110. However, the above-described configurations are only some of the configurations for explaining the operation method of the dispenser 10 to check whether the holder 24 is normally mounted to the cartridge 5, and it is natural that other configurations are included.

The main motor 30 may rotate the mounting body 21. In this regard, any description that is redundant with the description above will be omitted.

The rotation detection sensor 98 may detect whether the mounting body 21 is rotated. For example, the rotation detection sensor 98 may be an optical sensor. The optical sensor includes a transmitter (not shown) that emits light and a receiver (not shown) that receives light, and thus can detect light that is emitted and then returns after hitting an object. The controller 110 can obtain movement, speed, position, etc. of the object based on the amount of light reflected and received by the optical sensor.

As shown in FIG. 10, the rotation detection sensor 98 can be mounted on the lower plate 20a. At least one rotation detection bar B can be connected to the power transmission shaft 23, and thus, when the mounting body 21 rotates, the rotation detection bar B can also rotate. When the mounting body 21 does not rotate, the rotation detection bar B may not rotate. The rotation detection bar B can be installed to pass between the transmitter and receiver of the rotation detection sensor 98 when rotating. The amount of light detected by the rotation detection sensor 98 can change depending on whether the rotation detection bar B passes through. The controller 110 can obtain whether the rotation detection bar B passes, that is, whether the rotation detection bar B rotates, and whether the mounting body 21 rotates by using the change in the amount of light detected by the rotation detection sensor 98.

Meanwhile, the light sensor is only an example, and the rotation detection sensor 98 may be a different type of sensor.

The door sensor 99 can detect whether the door D is open or closed. For example, the door sensor 99 may be a Hall sensor. The Hall sensor can obtain the direction and size of the magnetic field by using the Hall effect, which generates a voltage in a direction perpendicular to the current and the magnetic field when a magnetic field is applied to a conductor through which a current flows. The Hall sensor can detect the change in the magnetic field that varies depending on the open or closed state of the door D.

As shown in FIG. 10, the door sensor 99 may be installed on the upper surface of the lower plate 20a. The door sensor 99 may be installed in a direction facing the door D. The controller 110 can determine whether door D is open or closed based on the change in magnetic field detected by door sensor 99.

Meanwhile, the Hall sensor is only an example, and the door sensor 99 may be a different type of sensor.

The controller 110 can control each of the main motor 30, the rotation detection sensor 98, and the door sensor 99.

FIG. 13 is a flowchart for explaining the operation method of the dispenser according to the embodiment of the present disclosure.

The controller 110 can detect the opening of door D S10.

The opening of door D may mean an event in which door D is switched from a closed state to an open state. The controller 110 may detect the switching of door D from a closed state to an open state using the sensing value of the door sensor 99.

If the door D is opened, the cartridge 5 replacement work, etc. may be performed.

If the opening of door D is detected, the controller 110 may detect whether the door D is closed S20.

The closing of door D may mean an event in which the door D is switched from an open state to a closed state. The controller 110 can detect that the door D has switched from an open state to a closed state using the sensing value of the door sensor 99.

When the closing of the door D is detected, the controller 110 can rotate the mounting body 21 at least once S30.

When the door D is opened and then closed, the controller 110 can perform an automatic mounting operation to normally mount the unmounted holder.

Specifically, when the closing of the door D is detected, there is a high possibility that the cartridge 5 replacement operation has been performed, so the controller 110 can perform an operation to automatically check whether the holder 24 is mounted on the cartridge 5.

The controller 110 can rotate the mounting body 21 at least once to check whether the holder 24 is mounted to the cartridge 5. The mounting body 21 can perform an automatic mounting operation to normally mount an unmounted holder, and in this case, can rotate at least once. That is, during the automatic mounting operation, the mounting body 21 can rotate at least once.

While the mounting body 21 rotates, the holder 24 normally mounted to the cartridge 5 can pass under the holder bracket 100. That is, the holder 24 normally mounted to the cartridge 5 may not come into contact with the holder bracket 100.

On the other hand, while the mounting body 21 rotates, the holder not mounted to the cartridge 5 can be mounted to the cartridge 5 by at least one of the first inclined surface 110 or the protrusion 101 formed on the bracket 100. That is, the holder not mounted to the cartridge 5 is applied pressure toward the cartridge 5 by coming into contact with the holder bracket 100, and thus can be mounted to the cartridge 5.

Meanwhile, among the holders not mounted to the cartridge 5, there may be a holder that is not mounted to the extent that it does not meet the first inclined surface 110. Specifically, if at least a part of the holder 24 exists higher than the maximum height of the first inclined surface 110, it may get caught on the holder bracket 100 and interfere with the rotation of the mounting body 21. That is, in some cases, some of the unmounted holders do not come into contact with the first inclined surface 110 while rotating, and thus the operation of automatically mounting to the cartridge 5 cannot be performed.

In this way, if there is a holder 24 that is left higher than the maximum height of the first inclined surface 110, the mounting body 21 may not rotate normally. That is, a rotation error may occur in the mounting body 21 due to the holder 24 being placed higher than the maximum height of the first inclined surface 110.

A rotation error in the mounting body 21 may mean an event in which the mounting body 21 does not rotate despite the operation of the main motor 30. A rotation error in the mounting body 21 may mean a case in which the mounting body 21 stops without rotating a set number of times during automatic mounting operation.

The controller 110 can detect whether there is the rotation error in the mounting body 21 by detecting whether the mounting body 21 rotates through the rotation detection sensor 98 S40.

If the controller 110 determines that the mounting body 21 does not rotate through the rotation detection sensor 98, the controller 110 can recognize the rotation error of the mounting body 21.

If the controller 110 detects the rotation error of the mounting body 21, the controller 110 can output an alarm indicating a holder mounting failure and stop the automatic mounting operation S50.

That is, if the controller 110 determines that the main motor 30 is operating but the mounting body 21 is not rotating, the controller 110 can output an alarm indicating a holder mounting failure and stop the operation of the main motor 30. If the mounting body 21 does not rotate, the controller 110 can output an alarm indicating a holder mounting failure and stop the automatic mounting operation.

The controller 110 can output an alarm indicating a holder mounting failure through the display 6. Alternatively, the controller 110 can transmit the alarm indicating a holder mounting failure to terminal 2.

In addition, the controller 110 can stop the main motor 30 because the user operation to mount the holder 24 is required in case of rotation error of the mounting body 21. If the user operation is performed, the door D will open and close, the controller 110 can output holder mounting failure alarm, stop operation, and then detect opening of the door D again.

Meanwhile, the controller 110 can prepare operation in discharge mode if rotation error of the mounting body 21 is not detected S60.

In summary, according to the embodiment of the present disclosure, the controller 110 can detect the open/close state of the door D to obtain whether the cartridge 5 is being replaced. For example, if the controller 110 detects that the door D is opened and then closed, the controller 110 can recognize that the cartridge 5 is being replaced.

If the controller 110 recognizes that the cartridge 5 is being replaced, the controller 110 can perform an automatic mounting operation. The controller 110 can rotate the mounting body 21 at least once during the automatic mounting operation. As the mounting body 21 rotates, the holder 24 can be mounted to the cartridge 5.

Meanwhile, the controller 110 can detect whether the mounting body 21 is rotated and obtain whether there is a holder 24 that cannot be mounted to the cartridge 5 through the automatic mounting operation. The controller 110 can output an alarm to notify the user when there is a holder 24 that cannot be mounted to the cartridge 5, and can stop the main motor 30 so that the user can manually mount the holder 24 to the cartridge 5.

Through this, the dispenser 10 according to the embodiment of the present disclosure can provide a function to check whether all cartridges 5 are properly mounted when there is a replacement task for the cartridge 5, and to automatically mount the cartridges 5 that are not properly mounted.

It is reasonable that the product manufactured by the dispenser 1 is not limited to cosmetics, and the type of the product is not limited.

The above description is merely an example of the technical idea of the present invention, and those with ordinary knowledge in the technical field to which the present invention belongs may make various modifications and variations without departing from the essential characteristics of the present invention.

Therefore, the embodiments disclosed in the present invention are not intended to limit the technical idea of the present invention, but to explain it, and the scope of the technical idea of the present invention is not limited by these embodiments.

The protection scope of the present invention should be interpreted by the claims below, and all technical ideas within the equivalent scope should be interpreted as being included in the scope of the rights of the present invention.

1. A dispenser, comprising:
a housing;
a main motor arranged inside the housing;
a mounting body that rotates by the main motor, equipped with a plurality of cartridges, and includes a plurality of holders that fix each of the plurality of cartridges; and
a holder bracket for normally mounting unmounted holder among the plurality of holders.

2. The dispenser of claim 1, wherein a protrusion that applies pressure to the unmounted holder is formed in the holder bracket.

3. The dispenser of claim 1, wherein at least one inclined surface is formed on a lower part of the holder bracket.

4. The dispenser of claim 3, wherein a height of the inclined surface decreases along a rotational direction of the mounting body.

5. The dispenser of claim 3, wherein the holder bracket is installed so that the inclined surface forms an angle of 5 to 85 degrees with a rotational plane of the mounting body.

6. The dispenser of claim 1, wherein the holder bracket is installed so as to be spaced apart from a holder that is normally connected by a predetermined distance.

7. The dispenser of claim 1, wherein the mounting body rotates at least once when performing an automatic mounting operation to normally mount the unmounted holder.

8. The dispenser of claim 7, further comprising a rotation detection sensor configured to detect whether the mounting body is rotated, and
the mounting body stops the automatic mounting operation if the mounting body does not rotate.

9. The dispenser of claim 8, further comprising a rotation detection sensor configured to detect whether the mounting body is rotated, and
output an alarm to indicate a poor holder mounting if the mounting body does not rotate.

10. The dispenser of claim 1, a door is formed on one side of the housing, and
when the door is opened and then closed, an automatic mounting operation is performed to normally mount the unmounted holder.

11. The dispenser of claim 10, further comprising a door sensor for detecting whether the door is opened or closed.

12. An operating method of a dispenser comprising a mounting body equipped with a plurality of cartridges and including a plurality of holders that fix each of the plurality of cartridges, a holder bracket, and a housing accommodating the mounting body and the holder bracket, comprising:
rotating the mounting body through a main motor; and
normally mounting unmounted holder among the plurality of holders through the holder bracket.

13. The operating method of claim 12, wherein normally mounting the unmounted holder comprises rotating the mounting body at least once by performing an automatic mounting operation.

14. The operating method of claim 13, wherein performing the automatic mounting operation comprises:
detecting whether the mounting body is rotated; and
stopping the automatic mounting operation if the mounting body does not rotate.

15. The operating method of claim 13, wherein performing the automatic mounting operation further comprises:
outputting an alarm to indicate a poor holder mounting if the mounting body does not rotate.

16. The operating method of claim 13, further comprising:
detecting whether a door formed on one side of the housing is opened or closed; and
performing the automatic mounting operation when the door is opened and then closed.
